(19) United States
(12) Patent Application Publication
(10) Pub. No.: US 2011/0244256 A1
(43) Pub. Date: Oct. 6, 2011

(54) Anticorrosion coatings containing silver for enhanced corrosion protection and antimicrobial activity

(76) Inventors: Zhiqiang Song, Newton, CT (US); Ted Deisenroth, Brookfield, CT (US); Richard Thomas, Nutley, NJ (US); Jacqueline Lau, Dobbs Ferry, NY (US)

(21) Appl. No.: 13/048,408

(22) Filed: Mar. 15, 2011

Related U.S. Application Data
(60) Provisional application No. 61/367,641, filed on Jul. 26, 2010.
(60) Provisional application No. 61/318,838, filed on Mar. 30, 2010.

(51) Int. Cl. B32B 15/08; B05D 1/36; B05D 5/00; C09D 5/16; B32B 15/088; B32B 15/09

(52) U.S. Cl. 428/458; 428/457; 428/461; 427/405; 427/2.1; 427/2.24; 523/122; 428/463

(57) ABSTRACT

Incorporating antimicrobial metals, such as silver salts, into an anticorrosion coating provides both excellent antimicrobial protection and surprisingly improves the anti corrosion activity as well, proving anti corrosion coatings effective as thin films and well suited for coating medical devices. Suitable binder polymers for the coating include but not limited to polyelectrolytes containing charged and/or potentially chargeable groups and polymers containing hydrophilic entities.

This application claims the benefit of U.S. Provisional Application Nos. 61/367,641, filed Jul. 26, 2010 and 61/318,838, filed Mar. 30, 2010 herein incorporated entirely by reference.

### FIELD OF THE INVENTION

The addition of certain antimicrobial metals, preferably salts of antimicrobial metals, such as silver salts, to anti-corrosive coatings surprisingly improves the protection of metals, such as those found in metallic medical devices and implants, against corrosion and substrate metal ion release while generating a multifunctional coating which also provides protection against, micro-organisms and bio-fouling.

### BACKGROUND

Metal corrosion is a serious problem in industries as varied as automotive manufacturing and the production of medical devices and implants, as it affects and eventually destroys integrity of metal structures.

Protection of metals from corrosion is much more difficult in highly aggressive environments such as sea water and human body which consist of aqueous electrolyte solutions containing large amounts of highly corrosive species such as chloride ions.

Most metals degrade in the human body and the choice of clinically usable metals is narrowed to mainly three types: stainless steels, cobalt-chromium, and titanium alloys. Although these medical metals and alloys have good corrosion resistance in general by comparison to other metals, living cells, tissues and biological fluids encountered by implants and medical devices are hostile environments for the survival of metal devices aggravating issues related to corrosion. Furthermore, the low toxicity tolerance of the human body to the effects of corrosion, such as the release of metal ions from steels, cobalt-chromium, and titanium alloys means that amounts of corrosion normally considered acceptable are to be avoided.

The release of toxic metal ions into tissue by corrosion or wear can cause tissue reactions ranging from a mild response such as discoloration of surrounding tissue to a severe one resulting in pain and even loosening the implant.

Controlling general corrosion at potential lower than the pitting breakdown potential (E_{b}), especially the free corrosion near the open circuit potential (OCP) or the corrosion potential (E_{cor}), is important since it can contribute significantly to metal ion release to the body in the application of medical implants causing patient's suffering. According to literature (Black, J., in “Biological Performance of Materials: Fundamentals of Biocompatibility”, Mercel Decker Inc, New York, 1992), the potential of metallic biomaterial can range from −1 to 1.2 V vs. SCE in the human body. The high potential in the human body can cause localized pitting corrosion and crevice corrosion even for well known corrosion resistant metal alloys such type 316L stainless steels (SS316L) which show a pitting breakdown potential ranging from 0.4 to 0.8 V vs. SCE.

For metallic medical devices and implants, problems due to bacterial infection, especially during the initial stage of the implant placement, and bio-fouling during the following implant service life are also significant factors in patient suffering and device failure.

Polyelectrolyte coatings are known to improve corrosion resistance. For example, US Pub Pat Application No. 2004/0265603A1 discloses an anticorrosion polyelectrolyte multilayer (PEM) coating comprising a polyelectrolyte complex of two oppositely charged polyelectrolytes. The polyelectrolytes are poly(diallyldimethylammonium chloride) and poly(styrene sulfonate) (PSS).

Silver salts such as those of nitrate, proteins, acetate, lactate and citrate have been used in anti-microbial coatings for medical devices.

Silver salts are known to have better anti-microbial efficacy than silver metal due to the instant ionization/dissociation to produce the Ag⁺ ion. The soluble salts are effective but do not provide long term protection and typically require frequent reapplication which is not always practical especially for medical implants. Attempts have been made to slow release of silver ions with silver containing complexes such as colloidal silver protein as disclosed in U.S. Pat. No. 2,785,153. U.S. Pat. No. 5,985,308 discloses a process for producing anti-microbial effect with complex silver ions for sustained silver ion release.

Clearly, there is a need to improve the corrosion resistance of metals, especially in medical devices; to eliminate localized pitting and crevice corrosions; to protect from metal ion release and to provide for inexpensive antimicrobial effect having sustained release of the antimicrobial agent at therapeutically active levels.

Accordingly, the inventors have surprisingly discovered that a coating containing select polymer binders and an antimicrobial metal, such as a silver salt, can exhibit significantly improve anticorrosion properties while maintaining an antimicrobial sustained release of silver metal or ions. The polymer binders may be those which are somewhat effective as anticorrosion coatings on their own, but the incorporation of the antimicrobial metal, such as a silver salt, greatly enhances the anticorrosion effectiveness of the coating. The incorporation of the antimicrobial metal offers the possibility of thinner coatings or less coating layers because of the improved corrosion properties of the combination of the binder polymer with the antimicrobial metal. Moreover, this increase is accomplished along with a sustained release of antimicrobial ions, highly desired in medical devices and implants.

### SUMMARY OF THE INVENTION

Accordingly the invention embodies:
A coated metal substrate, a method of protecting a metal substrate, a kit of parts and use of an antimicrobial metal to improve corrosion resistance of the coated metal substrate.

A coated metal substrate, wherein the metal substrate is coated with a film comprising

i.) a polymer binder,
ii.) an antimicrobial metal,
wherein the polymer binder comprises polymers selected from polyelectrolytes containing charged and/or potentially chargeable groups, preferably the polyelectrolyte is a complex derived from a positively-charged (cationic) polyelectrolyte and a negatively charged (anionic) polyelectrolyte and
polymers containing hydrophilic entities, preferably the polymers containing hydrophilic entities form a water-insoluble film,
and optionally, phytic acid or salts thereof,
wherein the antimicrobial metal is selected from silver, copper, gold, iridium, palladium or platinum.
A method of protecting a metal substrate from corrosion, release of substrate metal ion and microbial activity by
coating the substrate with a film comprising a polymer binder, an antimicrobial metal, preferably a antimicrobial metal salt and optionally phytic acid or salts thereof,
wherein the polymer binder comprises polymers selected from polyelectrolytes containing charged and/or potentially chargeable groups, preferably the polyelectrolyte is a complex derived from a positively-charged (cationic) polyelectrolyte and a negatively charged (anionic) polyelectrolyte and
polymers containing hydrophilic entities, preferably the polymers containing hydrophilic entities form a water-insoluble film,
and the antimicrobial metal is selected from silver, copper, gold, iridium, palladium or platinum.
A kit of parts is also envisioned
for the manufacture of a corrosion resistant metal substrate, comprising a first part (A) comprising an anionic polyelectrolyte containing negatively charged groups and a second part (B) comprising a cationic polyelectrolyte containing positively charged groups
or
a third part (C) comprising a polymer containing hydrophilic entities, preferably the polymers containing hydrophilic entities form water-insoluble film,
and
a forth part (D) comprising an antimicrobial metal, preferably antimicrobial salt,
and
optionally, a fifth part (E) comprising phytic acid or salts thereof,
which parts (A), (B), (D) and optionally (E) or parts (C), (D) and optionally (E) when applied to the metal substrate form a coated metal substrate as described above.

Use of an antimicrobial metal, preferably selected from the group consisting of salts of silver, copper, gold, iridium, palladium or platinum, to improve the corrosion resistance of a metal coating, preferably wherein the coating is on at least a part of a medical device or implant.

### DETAILED DESCRIPTION OF THE INVENTION

The term “comprising” for purposes of the invention is open ended, that is may include other components.

Metal Substrate

The metal substrate includes any materials which have a tendency to corrode. For example, the metals selected from the groups IA, IIA, IIIA, IVA, VA, VIA, IIIB, IVB, VB, VIIB, VIIB, VIII B, IB, IIB, of the periodic table. Metal includes alloys.

Typical metal substrates may be selected from the group consisting of iron, aluminum, magnesium, copper, titanium, beryllium, silicon, chromium, manganese, cobalt, nickel, palladium, lead, cerium, cadmium, molybdenum, hafnium, antimony, tungsten, tantalum, vanadium, mixtures and alloys thereof.

Preferably the metal substrate is steel, aluminum, titanium, chromium, cobalt mixtures or alloys thereof. Most preferably the metal substrate is a steel alloy such as stainless steel (316L), aluminum, titanium, titanium alloy or chromium-cobalt alloy.

The metal substrate may be any shape or form. The substrate, includes not only planar surfaces but three-dimensional substrates. For example, the substrate may be a flake, tube, pipe or metal parts.

Preferably the metal substrate is at least a part of a medial device or implant.

Polyelectrolyte

Polyelectrolytes are known to be polymeric or macromolecules containing substantial portions of repeat units which are charged or potentially charged. The polyelectrolytes may be either natural (protein, starches, celluloses, polypeptides) or synthetically derived polymers. The natural polymers may be modified natural polymers such as cationically modified starch or cationically modified cellulose. The polyelectrolytes bear a plurality of charged units arranged in a spatially regular or irregular manner. The charged units may be either anionic or cationic.

A positively charged (or chargeable) polyelectrolyte is called a cationic polyelectrolyte, cationic polymer, polycation or polybase. A negatively charged (or chargeable) polyelectrolyte is called an anionic polyelectrolyte, anionic polymer, polyanion or polyacid. A polyelectrolyte carrying both positively charged groups and negatively charged groups is referred to as amphoteric polyelectrolyte or polymer.

Polyelectrolytes can be strong or weak depending on the dissociation ability of the electrolyte groups they bear. A strong polyelectrolyte is one which dissociates completely in solution giving a charge density independent of pH (or for most reasonable pH values). In contrast, a weak polyelectrolyte is not fully charged but dissociates partially in solution only at certain pH range. The charge density of a weak polyelectrolyte in solution is therefore pH dependent. Strong polyelectrolytes contain strong acid and/or base moieties such as sulfate and sulfonate groups in anionic polyelectrolytes or quaternary ammonium groups in cationic polyelectrolytes. Weak polyelectrolytes contain weak acid and/or base moieties such as carboxylic acid and/or amino groups which become charged only at high (for acid) or low (for amino) pH.

Synthetic and natural polyelectrolytes can be used in the coatings of the present invention. Natural polymers include naturally occurring polyelectrolytes (such as proteins and polynucleic acids) and synthetically modified natural polyelectrolytes (such as modified celluloses, starches or modified starches and polypeptides or modified polypeptides).

The binder polymer of the invention preferably contains a complex formed from a positively-charged (cationic) polyelectrolyte (B) and a negatively charged (anionic) polyelectrolyte (A). The positively-charged (cationic) polyelectrolyte and the negatively charged (anionic) polyelectrolyte are each by themselves water-soluble. However, when they come in contact with one another, they complex via electrostatic interaction and/or hydrogen bonding interactions and the complex becomes water insoluble.

These polyelectrolytes can be conveniently applied as a coating by a simple method of layer-by-layer deposition in sequence of a cationic polymer (B) and an anionic polymer (A) in aqueous solutions to form a polyelectrolyte multilayer (PEM) film on the metal substrate.

Polyelectrolytes can be described in terms of charge density (meg/g) for both anionic and cationic polyelectrolyes.

Preferably the polyelectrolytes (A) and (B) each have a total charge density (q) of from about 0.5 to about 60 meq/g, more preferably from about 1.0 to about 40 meq/g, most preferably from about 2 to about 30, and especially from about 3.0 to about 20.

The total charge density includes contribution from any charged groups as well as potentially chargeable groups of weak electrolyte groups which become charged depending on pH. Thus, the total charge density for the polyelectrolyte is the sum of charge density (qₛ) contributed from strong electrolyte groups and the charge density (qₛ) contributed from a weak electrolyte groups: q=qₛ+q_{w}.

The molecular weight of the synthetic or natural polyelectrolyte (A) or (B) (either the cationic or anionic (A) and (B)) is typically about 1,000 to about 10,000,000 Daltons, preferably about 100,000 to about 3,000,000, most preferably about 5,000 to about 1,000,000.

The molecular weight specified is preferably weight average molecular weight (M_{w}) which can be determined by a typical light scattering method or a GPC (gel permeation chromatography) method.

Polyelectrolyte A

The polyelectrolyte anionic polymers (A) can be natural, modified natural polymers or synthetic polymers. Examples of natural and modified natural anionic polymers are alginic acid (or salts), carboxymethylcellulose, dextran sulfate or poly(galacturonic acid) or salts thereof.

Useful synthetic anionic polymers include polymers obtained from homopolymerization of at least one anionic monomer (Iₐ) or copolymerization of Iₐ with of at least one other copolymerizable monomer (II). Suitable anionic monomers (Iₐ) include, but are not limited to, (meth)acrylic acid (or salts), maleic acid (or anhydride), styrene sulfonic acid (or salts), vinyl sulfonic acid (or salts), allyl sulfonic acid (or salts), acrylamidopropyl sulfonic acid (or salts), and the like, wherein the salts of the said carboxylic acid and sulfonic acids are preferably neutralized with an ammonium cation or a metal cation selected from the group consisting Groups IA, IIA, IB and IIB of the Periodic Table of Elements.

Preferred cations of the polyelectrolyte anionic polymer are ammonium cations (NH₄⁺) and ⁺N(CH₃)₄ and most preferred metal cations are K⁺ and Na⁺.

Suitable water-soluble anionic polymers are reaction products of about 0.1 to about 100 weight percent, preferably about 10 to about 100 weight percent, most preferably about 50 to about 100 weight percent, of at least one anionic monomer Iₐ, and optionally about 0 to about 99.9 weight percent, preferably about 0 to about 90 weight percent, most preferably about 0 to about 50 weight percent, of one or more other copolymerizable monomers (II), and optionally, about 0 to about 10 weight percent of a crosslinking agent (III).

Thus the preferred polyelectrolyte anionic synthetic polymers (A) are homopolymers or copolymers of (meth)acrylic acid, maleic acid (or anhydride), styrene sulfonic acid, vinyl sulfonic acid, allyl sulfonic acid, acrylamidopropyl sulfonic acid or salts thereof.

The preferred polyelectrolyte anionic natural polymers are alginate. carboxymethylcellulose, dextran sulfate or poly(galacturonic acid).

Thus the preferred combined synthetic and natural polyelectrolyte anionic polymers (A) are homopolymers or copolymers of (meth)acrylic acid, maleic acid (or anhydride), styrene sulfonic acid, vinyl sulfonic acid, allyl sulfonic acid, acrylamidopropyl sulfonic acid, alginic acid, carboxymethylcellulose, dextran sulfate or poly(galacturonic acid) or salts thereof.

The most preferred anionic polyelectrolytes (both synthetic and natural or modified natural) are polystyrenesulfonate (PSS), poly(styrenesulfonate-co-maleic acid), alginic acid, carboxymethylcellulose, dextran sulfate, poly(galacturonic acid) or salts thereof.

Polyelectrolyte B

The cationic polymers can be natural, modified natural polymers or synthetic polymers. Examples of natural and modified natural cationic polymers are chitosan, cationic starch, polylysine and salts thereof.

The preferred synthetic cationic polymers include polymers obtained from homopolymerization of at least one cationic monomer (I_{b}) or copolymerization of I_{b} with a copolymerizable monomer (II). Suitable cationic monomers (I_{b}) include, but are not limited to, diallyldimethyl ammonium chloride (DADMAC), diallyldimethyl ammonium bromide, diallyldimethyl ammonium sulfate, diallyldimethyl ammonium phosphates, dimethallyldimethyl ammonium chloride, diethylallyl dimethyl ammonium chloride, diallyl di(beta-hydroxyethyl)ammonium chloride, and diallyl di(beta-ethoxyethyl)ammonium chloride, aminoalkyl acrylates such as dimethylaminoethyl acrylate, diethylaminoethyl acrylate, and 7-amino-3,7-dimethyloctyl acrylate, and their salts including their alkyl and benzyl quaternized salts; N,N′-dimethylaminopropyl acrylamide and its salts, allylamine and its salts, diallylamine and its salts, vinylamine (obtained by hydrolysis of vinyl alkylamide polymers) and its salts and vinyl pyridine and its salts.

Thus the preferred cationic synthetic polyelectrolyte (B) are homopolymers or copolymers of diallyldimethyl ammonium chloride (DADMAC), diallyldimethyl ammonium bromide, diallyldimethyl ammonium sulfate, diallyldimethyl ammonium phosphates, dimethallyldimethyl ammonium chloride, diethylallyl dimethyl ammonium chloride, diallyl di(beta-hydroxyethyl)ammonium chloride, and diallyl di(beta-ethoxyethyl)ammonium chloride, aminoalkyl acrylates such as dimethylaminoethyl acrylate, diethylaminoethyl acrylate, and 7-amino-3,7-dimethyloctyl acrylate, and their salts including their alkyl and benzyl quaternized salts; N,N′-dimethylaminopropyl acrylamide and its salts, allylamine and its salts, diallylamine and its salts, vinylamine (obtained by hydrolysis of vinyl alkylamide polymers) and its salts and vinyl pyridine and its salts.

The preferred cationic natural polymers or modified natural polymers are chitosan, cationic starch, polylysine and salts thereof.

Thus the cationic polyelectrolyte (B) are preferably homopolymers or copolymers of diallyldimethyl ammonium chloride (DADMAC), diallyldimethyl ammonium bromide, diallyldimethyl ammonium sulfate, diallyldimethyl ammonium phosphates, dimethallyldimethyl ammonium chloride, diethylallyl dimethyl ammonium chloride, diallyl di(beta-hydroxyethyl)ammonium chloride, diallyl di(beta-ethoxyethyl)ammonium chloride, dimethylaminoethyl(meth)acrylate acid addition salts and quaternary salts, diethylaminoethyl(meth)acrylate acid addition salts and quaternary salts, 7-amino-3,7-dimethyloctyl(meth)acrylate acid addition salts and quaternary salts, N,N′-dimethylaminopropyl acrylamide acid addition salts and quaternized salts, wherein the quaternary salts include alkyl and benzyl quaternized salts; allylamine, diallylamine, vinylamine (obtained by hydrolysis of vinyl alkylamide polymers), vinyl pyridine, chitosan, cationic starch, polylysine and salts thereof.

In a more preferred embodiment, the synthetic cationic polyelectrolyte (B) is a homopolymer or copolymer of DADMAC, dimethylaminoethyl acrylate or salts thereof including alkyl and benzyl quaternized salts.

The most preferred cationic polyelectrolytes for (B) (synthetic and natural) are DADMAC homopolymers (pDAD), copolymers of DADMAC with diallylamine, chitosan, cationic starch, polylysine and salts thereof.

Suitable water-soluble cationic polymers are preferably reaction products of about 0.1 to about 100 weight percent, most preferably about 10 to about 100 weight percent, especially about 50 to about 100 weight percent, of at least one cationic monomer I_{b}, preferably about 0 to about 90 weight percent, most preferably about 0 to about 50 weight percent, of one or more other copolymerizable monomers (II), and optionally, about 0 to about 10 weight percent of a crosslinking agent (III).

One particular embodiment makes use of PEMs featuring polyelectrolyte pairs (A) and (B) containing both strong and weak ionic groups in coatings for metallic medical devices and implants.

PEM systems featuring polyelectrolyte pairs (A) and (B) wherein each polyelectrolyte contains both strong and weak ionic groups is especially effective in achieving high corrosion resistance. These allow for post crosslinking for improved mechanical stability and improved anticorrosion effect. US co-pending Provisional Application No. 61/367,641 herein incorporated entirely by reference described these systems in detail.

Strong anionic groups are preferably sulfate, sulfonate, phosphate, hydrogen phosphite, phosphoric acid, mixtures or salts thereof. Accordingly, a synthetic polyelectrolyte (A) may be formed from monomers containing a sulfate, sulfonic acid, phosphate, hydrogen phosphite, phosphoric acid and phosphonic acid groups which when polymerized will give repeat units containing these moieties.

Weak groups are not fully charged but dissociate partially in solution depending on the pH of the solution or dispersion containing the polyelectrolyte (A) containing the weak anionic moities. The charge density of the weak anionic group is therefore pH dependent. For example, a weak anionic group will normally be more completely dissociated (ionized) at a high pH. The weak anionic group will typically be a carboxylic acid. The carboxylic group is located on the repeat units of polyelectrolyte (A) and the repeat units may be formed from monomers containing a carboxylic acid.

The number of weak anionic groups become deprotonated or negatively charged will increase with increasing pH.

A preferred embodiment is an polyelectrolyte (A) containing strong and weak anionic groups wherein the strong anionic groups are sulfate, sulfonic acid, phosphate, hydrogen phosphite, phosphoric acid and phosphonic acid groups and the weak groups are carboxylic acid groups.

Preferably synthetic polyelectrolyte (A) is a copolymer of styrene sulfonic acids, vinylsulfonic acid, allyl sulfonic acid, (meth)acrylamidopropyl sulfonic acid, vinyl phosphonic acid and salts thereof, especially styrene sulfonic acids and (meth)acrylamidopropyl sulfonic acid and salts thereof

and
(meth)acrylic acid, maleic acid or anhydride, itaconic acid or anhydride, crotonic acid, mixtures and salts thereof, especially (meth) acrylic acid, maleic acid, itaconic acid.

Strong and weak cationic polyelectrolytes (B) are analogous to the strong and weak groups of the anionic polyelectrolytes (A) described above.

The strong cationic polyelectrolyte groups of (B) are permanent cationic groups independent of pH.

Strong cationic polyelectrolytes are preferably polymers containing quaternary ammonium, sulfonium, phosphonium groups, mixtures or salts thereof. Accordingly, a synthetic polyelectrolyte (B) may be formed from monomers containing a quaternary ammonium, sulfonium, phosphonium groups which when polymerized will give repeat units containing these moieties.

The B polyelectrolyte may be a natural polymer containing strong and cationically charged groups. For example, quaternized chitosan and cationic starch are well known in the art.

In contrast to the strong cationic groups on the polyelectrolyte (B), the term weak in reference to (B) means these groups are not fully charged but dissociate partially in solution depending on the pH of the solution or dispersion containing the polyelectrolyte (B). The charge density of the weak base group is therefore pH dependent. For example, a weak cationic group will normally be more completely dissociated (ionized) at a low pH. The weak cationic group will typically be a primary, secondary or tertiary amine. The amine is located on the repeat unit of the polyelectrolyte (B) and the repeat units may be formed from monomers containing the primary, secondary, tertiary amine or acid addition salts thereof.

A weak cationic group can become positively charged when it associated with a positively charged proton H⁺ and thus the pH will affect the amount of the protonated cationic weak groups. The amount of cationic weak groups become protonated or positively charged will increase with decreasing pH.

Preferably the polyelectrolyte (B) is a synthetic copolymer of diallyldimethyl ammonium chloride (DADMAC), diallyldimethyl ammonium bromide, diallyldimethyl ammonium sulfate, diallyldimethyl ammonium phosphates, diethylallyl dimethyl ammonium chloride, diallyl di(beta-hydroxyethyl)ammonium chloride, and diallyl di(beta-ethoxyethyl)ammonium chloride, dimethallyldimethyl ammonium chloride, dimethylaminoethyl(meth)acrylate methyl chloride quaternary, diethylaminoethyl(meth)acrylate methyl chloride quaternary, dimethylaminoethyl(meth)acrylate dimethylsulfate quaternary, dimethylaminoethyl(meth)acrylate benzyl chloride quaternary

and
diallyamine, vinylimidazole, vinyl pyridine, vinyl amine (obtained by hydrolysis of vinylalkylamide polymers), dimethylaminoethyl(meth)acrylate and salts thereof
or
a natural polymer of cationic starch, lysine or chitosan.

### Binder Polymers Containing Hydrophilic Entities

The invention further embodies the binder polymers containing hydrophilic entities in combination with an antimicrobial metal, preferably a metal salt to produce an improved corrosion resistant coating, especially on at least a part of a medical device and implant.

Preferably the polymers binders binder comprising polymers selected from polyelectrolytes containing charged and/or potentially chargeable groups, preferably the polyelectrolyte is a complex derived from a positively-charged (cationic) polyelectrolyte and a negatively charged (anionic) polyelectrolyte and polymer containing hydrophilic entities, preferably the polymers containing hydrophilic entities forms a water-insoluble film.

Examples of water-insoluble polymers containing hydrophilic entities include copolymers of styrene and vinylpyridine, homopolymers and copolymers of vinylpyridine, homopolymers and copolymers of terbutylaminoethyl methacrylate.

Thus preferably, the polymer binders containing hydrophilic entities include copolymers of styrene and vinylpyridine, homopolymers and copolymers of vinylpyridine, homopolymers and copolymer of terbutylaminoethylmethacrylate,

Most preferably, the polymer binders containing hydrophilic entities include a water-insoluble polymer coatings are made from block copolymers of vinylpyridine and styrene.

### Antimicrobial Metals

Incorporating certain antimicrobial metal such as silver, copper, gold, iridium, palladium and platinum, preferably salts or ions of antimicrobial metals silver, copper, gold, iridium, palladium and platinum into an anticorrosion coating provides both excellent antimicrobial protection and surprisingly improves the anticorrosion activity as well.

Coatings of the invention, such as silver ion containing polyelectrolyte multilayer coatings, give excellent corrosion resistance to medical metals and alloys such as type 316L stainless steel. The coatings improve corrosion resistance of medical metal substrates prolonging implant service time and reducing release of harmful substrate metal ions to the body and provide antimicrobial effect for infection control of medical implants.

Suitable antimicrobial metals, preferably salts or antimicrobial metal ions for the coating of the present invention to improve corrosion protection include ions from noble metals such as silver, copper, gold, iridium, palladium and platinum, for example, metal ions from silver and copper with known antimicrobial activity such as monovalent Ag(I) (or Ag⁺) and divalent Ag(II) (or Ag²⁺), silver ions, both of which are known to be excellent antimicrobial and biocide agents.

Antimicrobial silver salts or silver ions are preferred.

Silver ions can be incorporated into the coatings by using inorganic and/or organic silver salts or complex silver ions.

Exemplary silver salt compounds include silver nitrate, silver sulfate, silver fluoride, silver acetate, silver permanganate, silver nitrite, silver bromate, silver salicylate, silver iodate, silver dichromate, silver chromate, silver carbonate, silver citrate, silver phosphate, silver chloride, silver bromide, silver iodide, silver cyanide, silver, silver sulfite, stearate, silver benzoate, and silver oxalate.

The above list of silver salts has reasonable water solubility and are well suited for use in solution for treating the polymer coating on the metal substrate.

Many complex ions, such as complex silver ions, also have excellent antimicrobial activity and can be used in the present invention. Examples of complex silver ions include Ag(CN)₂⁻, Ag(NH₃)₂⁺, AgCl₂⁻, Ag(OH)₂⁻, Ag₂(OH)₃⁻, Ag₃(OH)₄⁻, and Ag(S₂O₃)₂³⁻. The complex sliver ions can be prepared from a silver salt in an aqueous medium containing excessive amounts of a cationic or anionic or neutral species which are to be complexed with silver. For example, AgCl₂⁻ complex ions can be generated by placing AgNO₃ salt in an aqueous solution containing excessive amount of NaCl. Similarly, the Ag(NH₃)₂⁺ complex ions can be formed in aqueous solution by adding silver salt to excess ammonium hydroxide. The Ag(S₂O₃)₂³⁻ ions may be formed in aqueous solution by adding AgNO₃ to excess sodium thiosulfate.

Thus the antimicrobial metal is preferably a salt which most preferably is a silver salt or complex of silver and is selected from the group consisting of silver nitrate, silver sulfate, silver fluoride, silver acetate, silver permanganate, silver nitrite, silver bromate, silver salicylate, silver iodate, silver dichromate, silver chromate, silver carbonate, silver citrate, silver phosphate, silver chloride, silver bromide, silver iodide, silver cyanide, silver, silver sulfite, stearate, silver benzoate, silver oxalate, Ag(CN)₂⁻, Ag(NH₃)₂⁺, Ag(OH)₂⁻, Ag₂(OH)₃⁻, Ag₃(OH)₄⁻, and Ag(S₂O₃)₂³⁻.

Application of the Coatings and Incorporation of Antimicrobial Salt into the Coatings

The coatings or the polymer binder of the invention may be applied to the metal substrates by any means known in the art e.g., brushing, spraying, drop casting, spin coating, draw down, substrate immersion etc. However, immersion or dipping for a specific period of time is a simple and reproducible process providing excellent results and is an excellent approach for layer by layer deposition.

For example, the polyelectrolytes (A) and (B) can be formed by a sequence wherein a substrate is conveniently immersed or dipped into a solution of a cationic polymer, removed, rinsed, and then immersed or dipped into a solution of an anionic polymer before being removed and rinsed. The sequence may be repeated until a film of the desired thickness is prepared. No drying is required between application of the polyelectrolyte (A) and (B).

Incorporation of the antimicrobial metal ions into the coating can be realized either by first applying the polymer binder on the substrate and then treating the applied binder with a solution containing the antimicrobial metal or antimicrobial metal ions can be incorporated into the polymer first followed by applying the antimicrobial metal ion containing polymer to the substrate.

In one alternate embodiment, the antimicrobial metal ion containing coating is achieved by using a polymer containing functional groups capable of complexing with antimicrobial ions in the coating composition; in another embodiment by coating the substrate with a polymer coating composition in which the antimicrobial salt is dissolved.

In another embodiment, the silver can be incorporated in one of the polyelectrolyte solutions used for PEM coating preparation and then applied to the metal.

One particular method for preparing a metal containing polymer of the invention, such as a silver containing polymer, involves bringing a metal compound or salt, e.g., a silver metal compound or silver metal salt in contact with an environment containing a polymer having capability of binding or complexing with silver. Polymers capable of complexing with silver include anionic polymers or anionic polyelectrolytes which contain anionic acid functional groups such as carboxylate, sulfate, sulfonate, phosphate, and phosphonate for electrostatic complexing with positive silver ions.

Examples of such silver containing anionic polymers include but not limited to silver salts of poly(acrylic acid), and silver salts of copolymers of acrylic acid with copolymerizable monomers, poly(maleic acid) and copolymers of maleic acid, poly(styrenesulfonic acid) and copolymers of styrenesulfonic acid such as poly(styrenesulfonate-co-maleic acid), poly(vinyl sulfate) and copolymers of vinyl sulfate, polyvinylsulfonate and copolymers of vinyl sulfonate, poly(vinylphosphonic acid) and copolymers of vinylphosphonic acid, poly(vinylphosphoric acid) and copolymers of vinylphosphoric acid.

Polymers containing metal chelating functional groups can also be used to prepare a metal containing polymer, e.g., a silver containing polymer. The metal chelating functional groups include but not limited to (primary, secondary and tertiary) amino groups and ketocarboxylate such as acetoacetate groups. Example of such polymers are (homo- and co-) polymers of vinylpyridine, vinylimidazole, diallylamines which cyclopolymerized to give pyrrolidine functional groups, allyamine, vinylamine (derivatives of vinylacetamine polymers), dimethylaminoethyl acrylate and 2-(acetoacetyl)ethyl methacrylate. Polymers containing amino groups are potential cationic polymers or polyelectrolytes when being neutralized with an acid.

The coatings of the invention provide excellent anticorrosion activity even when applied as thin films, e.g., less than about 10 microns for example less than about 5, about 2 or about 1 micron thick and in certain embodiments less than about 0.5 or about 0.1 micron.

The coatings of the present invention are preferably from about 0.05 to about 15 microns thick.

Phytic Acid and/or Salts Thereof

In another embodiment, the coating optionally comprises phytic acid and/or salts of phytic acid. The application of phytic acid to the metal substrate can take place either as a pretreatment before coating with the binder polymer and antimicrobial, simultaneously with the binder polymer and antimicrobial salt or after the binder and antimicrobial salt or applied. The phytic acid may be also be applied in combination with the silver salt before application of the binder polymer.

Alternatively it can also be incorporated in one or both polyelectrolyte solutions used for applying the PEM coatings on substrate.

Preferably the phytic acid is applied directly to the metal substrate surface before the polymer binder and antimicrobial metal is applied.

Film thickness, morphology and layer-by-layer film buildup is measured using AFM and ATR-FTIR. Electrochemical methods are used to evaluate corrosion of uncoated and coated samples.

### EXAMPLES

### Electrochemical Corrosion Tests

In the following examples, standard electrochemical tests are run to assess anticorrosion properties of coated and uncoated (also referred to as bare) samples. The substrate to be tested, for example a coated or uncoated metal wire, is placed in an electrochemical cell containing an electrolyte solution (0.7M NaCl in deionized water with a pH of about 6.0 or phosphate buffered saline (PBS) with a pH of 7.4), so that the area of the substrate immersed dipped in the electrolyte solution is 1.0 cm². The substrate is used as a working electrode in an electrochemical cell containing the electrolyte solution, a Ag/AgCl (3M NaCl) reference electrode and a platinum wire counter electrode. The electrolyte solution in the cell is purged with high purity nitrogen before starting the testing. The tests are carried out continuously in the sequence listed in Table B.

TABLE B
Electrochemical corrosion tests and testing conditions

| step | Measurements |
|---|---|
| OCP-1 | Open circuit potential (OCP) monitoring 5000 sec |
| Zplot-1 | Impedance spectroscopy: AC amplitude 5 mV vs OCP frequency |
| | scan from 300k to 0.05 Hz |
| PD-1 | Potentiodynamic polarization: sweep from −100 mV (vs OCP) to |
| | +900 mV (vs ref) at 0.1667 mV/s scan rate |
| PS-1 | Potentiostatic polarization: +600 mV/300 sec |
| OCP-2 | OCP monitoring 3000 sec |
| PS-2 | Potentiostatic polarization: +700 mV/14 h |
| OCP-3 | OCP monitoring 3000 sec |
| Zplot-2 | Impedance spectroscopy: AC amplitude 5 mV vs OCP frequency |
| | scan 300k to 0.05 Hz |

Open circuit potential (OCP) monitoring, anodic polarization scans and chronoamperometric scans were obtained using a SOLARTRON 1287A ELECTROCHEMICAL INTERFACER (ECI) with CORRWARE software. The Electrochemical Impedance Spectroscopy (EIS) was carried out using a SOLARTRON 1252A FREQUENCY RESPONSE ANALYZER (FRA) with a ZPLOT software over the frequency (f) of 300,000 to 0.05 Hz with 5 mV AC amplitude.

The PD-1 measurement provides corrosion potential, E_{corr}, corrosion current, I_{corr} and polarization resistance, Rₚ, of free corrosion near OCP, pitting and breakdown corrosion potential, E_{b}. The PS-2 measurement tests long term durability of the coatings, i.e., 14 hours testing of static anodic polarization at pitting breakdown potential of bare type 316 stainless steel (700 mV). When pitting breakdown occurs during the PS-2 test, the time it begins (t_{b}) is reported.

Traditional Tafel fit of the polarization scans near E_{oc} using CORRVIEW software yields data on corrosion current (I_{corr}, μA/cm²), corrosion potential (E_{corr}, mV), and beta Tafel constants Ba and Bc. Polarization resistance is calculated using the Stern-Geary relationship: Rₚ=(Ba*Bc)/[2.303*(Ba+Bc)*I_{corr}]

In general, the corrosion potential (E_{corr}) is slightly lower than, but close to, the open circuit potential (EA.

The EIS analysis (Zplot-1) just before the PD-1 measurement gives information about free corrosion properties near the open circuit potential (OCP). The polarization resistance is given by the difference of measured impedance (Z) at sufficiently low and high frequencies (f). (Impedance Spectrosopcpy: Theory, Experiment, and Applications, Edited by E. Barsoukov and J. R. MacDonald, John Wiley & Sons, NJ, 2005, page 344)

Rₚ=Z(f→0)−Z(f→∞)

As the value of the impedance at high frequency is usually negligible compared to that of the impedance at low frequency, the value of the polarization resistance is close to the impedance at low frequency. In the present study, data of the impedance at 0.05 Hz, Z (0.05 Hz) measured in Zplot-1 testing, is used to compare corrosion resistance of different samples. Similar to Rₚ, a high Z (0.05 Hz) value indicates high corrosion resistance.

### Preparation of Coated Samples

### General Procedure for Layer-by-Layer Deposition of Polyelectrolyte Multilayers

Layer-by-layer (LbL) assembled polyelectrolyte multilayer (PEM) films were prepared by sequential dipping of a substrate into a cationic polyelectrolyte solution (polymer B) followed by rinsing and dipping into an anionic polyelectrolyte solution (polymer A) according to the following general procedure:
1. Dip substrate in Polymer B solution for 10 minutes;
2. Rinse in DIW for 3 minutes;
3. Dip in Polymer A solution for 10 minutes;
4. Rinse in DIW for 3 minutes; record (B/A), double layer number, i
5. Stop if coated double layer number i equal to the desired number, n; otherwise go back to step 1 and repeat

If n is a whole number such as n=20, the PEM coating has 20 double layers and ends with anionic polymer A as the outmost layer. If n contains a fraction, i.e., a half number such as n=20.5, the PEM coating has 20.5 double layers and ends with cationic polymer B as the outmost layer.

The materials used for the preparation of polyelectrolyte multilayer coatings are shown in Table A.

TABLE A
materials used for the preparation of polyelectrolyte multilayer coatings

| | Chemical name and composition | Abbr. |
|---|---|---|
| A1 | poly(styrenesulfonate-co-maleic acid) sodium salt; | PSSMA25 |
| | ( 3:1) 4-styrenesulfonic acid:maleic acid mole ratio, | |
| | powder, M_{w} ~20,000 | |
| A2 | Poly(styrenesulfonate sodium), MW 70k | PSS70 |
| A6a | Poly(acrylic acid) | PAA |
| A13 | Dextran sulfate | DXS |
| A14 | Poly(galacturonic acid) | PGA |
| B2 | Poly(diallylamine-co-DADMAC) 25/75 mole, 30.6% | DAA25 |
| | active(11zs8C6) | |
| B5 | Poly(allylamine)hydrochloride | PAH |
| B7 | Poly(diallyldimethylammonium chloride), | pDAD |
| | pDADMAC, Alcofix 111 | |
| B8 | Chitosan | CTS |
| D1 | Phytic acid | PY |

### Example 1

### PEM2 Coatings with 20 Double Layers of Polymer A1 and Polymer B2

Vacuum arc remelted stainless steel 316LVM (ASTM F138 chemistry) wires (1.25 mm in diameter) were abraded with SiC 1200 grit sand paper, degreased with isopropanol, and then washed with deionized water (DIW) in an ultrasonic bath for 10 minutes.

Polyelectrolyte multilayer coatings of 20 double layers of polymer A1 and polymer B2 (PEM2)₂₀ are deposited on the freshly abraded and ultrasonically cleaned 316LVM stainless steel wires following the above general layer-by-layer deposition method using a 10 mM poly(styrenesulfonate-co-maleic acid) sodium salt (A1) in 0.25M NaCl aqueous solution as the dipping solution for Polymer A solution and a 10 mM Poly(diallylamine-co-DAD MAC) (B2) in 0.25M aqueous solution as the dipping solution for Polymer B.

Incorporation of silver salt into the PEM2 coatings containing silver was accomplished by immersing the PEM2 coated SS316LVM wires in 0.25M silver nitrate aqueous solution overnight followed by rinsing with deionized water (DIW) and drying under a nitrogen stream. Uncoated SS316LVM wires were also treated in the same conditions for comparison in corrosion testing. Uncoated abraded and washed wires were also reserved as a control for testing.

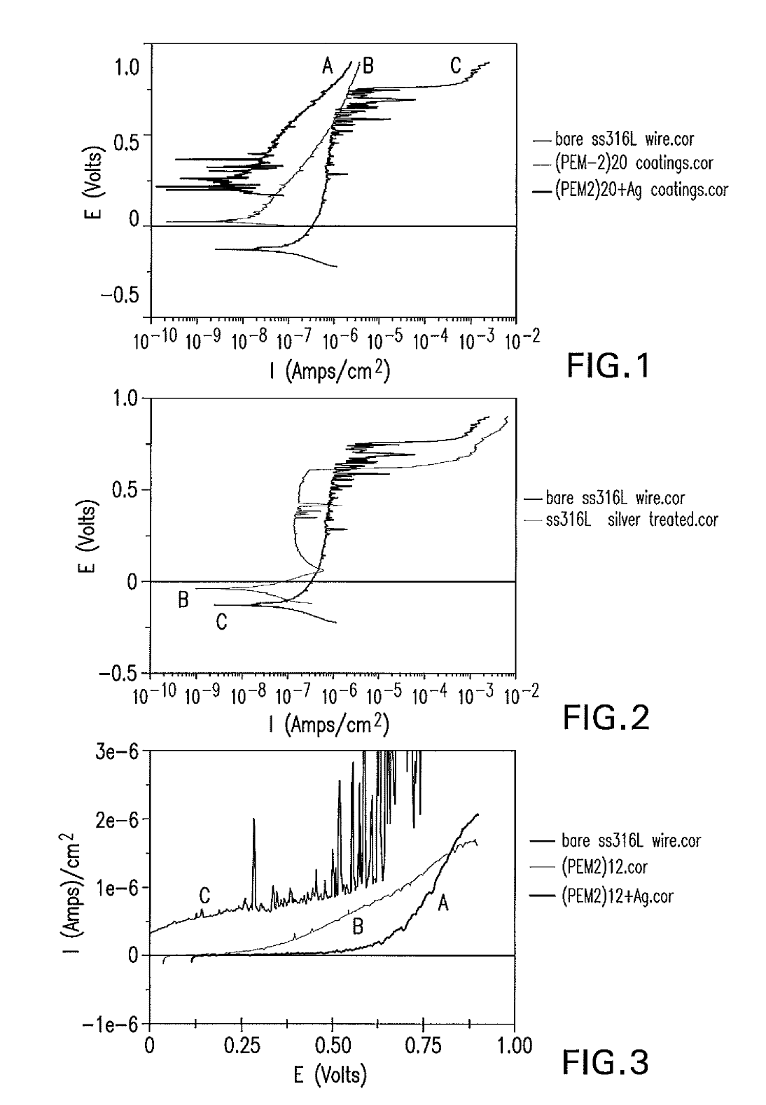

Electrochemical corrosion tests were carried out on coated and uncoated SS316LVM wires in 0.7M NaCl solution. The potentiodynamic polarization curves from the PD-1 testing are compared in FIG. 1 for bare SS316L wire (B curve), SS316L wire coated with 20 double layer PEM-2 polymers (C curve), and SS316L wire coated with 20 double layers of PEM-2 polymers and treated with silver solution (A curve). Bare SS316L wires show significant pitting corrosion with a breakdown potential E_{b} of 700 mV, beyond which a sustained corrosion current occurs. The plot for bare wire also contains random current spikes indicating meta-stable pitting before pitting breakdown at 700 mV. Wires coated with 20 double layer of PEM-2 coatings exhibit significant improvement in corrosion resistance. The meta-stable pitting is suppressed and there is no pitting breakdown up to the 900 mV potential observed. Treatment of the PEM-2 coated wires with AgNO₃ solution provides significantly further improvement in corrosion resistance. The anodic polarization current for (PEM-2)₂₀+Ag coatings is significantly lower than that for (PEM-2)₂₀ coatings only (FIG. 1). The free corrosion properties near OCP are also improved significantly as shown by the data in Table 1. With silver solution treatment on the PEM-2 coated SS316LVM wires, the corrosion potential, E_{corr}, increased from 21 to 84 mV, corrosion current, I_{corr}, decreased about 5 times from about 30 to 6 nA/cm², and the polarization resistance, Rₚ, increased more than 7 times from 714 to 5440 kΩ*cm².

For comparison (see comparative example 1 for more details), the silver treated and bare SS316LVM wires are subjected to the same electrochemical corrosion tests. SS316LVM treated only with silver solution gave little improvement in anti-corrosion properties. The treatment of SS316L with the silver salt solution raised the corrosion potential, E_{corr} but did not suppress pitting corrosion breakdown. In fact, the silver treated wire had a pitting corrosion breakdown potential (610 mV) lower than that (700 mV) for untreated wire.

This example demonstrated synergy of the silver salt solution treatment with polyelectrolyte multilayer (PEM) coatings for anti-corrosion improvement on medical grade SS316LVM stainless steel. Significant improvement in anti-corrosion properties can be achieved by silver treatment of coated SS316LVM.

TABLE 1
Data from Zplot-1, PD-1 and PS-2 tests for SS316L wires uncoated and coated with PEM-2.

| | | Z(0.05 Hz) | E_{corr} | I_{corr} | Rₚ | E_{b} | t_{b}(700 mV) |
|---|---|---|---|---|---|---|---|
| Wire ID | coatings | kΩ*cm² | mV | μA/cm² | kΩ*cm² | mV | hr |
| Bare SS316L | no | 30 | −128 | 0.093 | 285 | 700 | 0 |
| 16zs200DW | (PEM-2)₂₀ | 60 | 21 | 0.029 | 714 | No | >14 |
| 16zs200DWAg | (PEM- | 81 | 84 | 0.006 | 5440 | No | >14 |
| | 2)₂₀ + Ag | | | | | | |

See FIG. 1: Potentiodynamic polarization curves from the PD-1 testing, bare SS316L wire (curve C), SS316L wire coated with 20 double layer PEM-2 polymers (curve B), and SS316L wire coated with 20 double layers of PEM-2 polymers and treated with silver solution (curve A)

### Comparative Example 1

### Silver Wire Treated Only with Silver Salt

Uncoated bare SS316LVM wires are abraded and washed as above and then immersed in 0.25M silver nitrate aqueous solution overnight. The treated wires are rinsed with deionized water (DIW) and dried with a nitrogen stream and subjected to the same electrochemical corrosion tests as in Example 1. As can be seen from FIG. 2 and Table 2, wires treated only with silver solution gave little improvement in anti-corrosion properties. The treatment of SS316L wire with the silver salt solution raised the corrosion potential, E_{corr} but did not suppress pitting corrosion breakdown. In fact, the silver treated wire had a pitting corrosion breakdown potential (610 mV) lower than that (700 mV) for untreated wire.

TABLE 2
Data from Zplot-1, PD-1 and PS-2 tests for Ag treated and untreated SS316L wires.

| | | E_{corr} | I_{corr} | Rₚ | E_{b} | t_{b}(700 mV) | Z(0.05 Hz) |
|---|---|---|---|---|---|---|---|
| Wire ID | reference | mV | μA/cm² | kΩ/cm² | mv | hr | kΩ/cm² |
| Bare SS316L | Bare 316 | −128 | 0.093 | 285 | 700 | 0 | 30 |
| SS316L Ag treated | 16zs214SS-Ag | −45 | 0.010 | 1410 | 610 | 0 | 50 |

See FIG. 2: Potentiodynamic polarization curves from the PD-1 testing, bare SS316L wire (curve C), SS316L wire treated with AgNO₃ solution (curve B)

### Example 2

### PEM2 Coatings with 12 Double Layers of Polymer A1 and Polymer B2

The procedure of Example 1 is repeated except that 12 instead of 20 double layers of polymer A1 and polymer B2 (PEM2)₁₂, with and without silver salts, were deposited on the wires. The PD-1 electrochemical corrosion testing results are shown in FIG. 3 and Table 3. The silver treated PEM2 coatings gave low corrosion current density (I_{corr}) and high corrosion potential (E_{corr}) and polarization resistance (Rₚ). The benefit of improved anticorrosion properties from incorporating silver ions in the PEM2 coatings can also be seen with reduced double layers number (12) and thus decreased coating film thickness.

TABLE 3
Data from PD-1 testing

| | | E_{corr} | I_{corr} | Rₚ | E_{b} |
|---|---|---|---|---|---|
| Wire ID | coatings | mV | μA/cm² | kΩ * cm² | mV |
| Bare SS316L | No | −128 | 0.093 | 285 | 700 |
| PEM12W2 | (PEM-2)₁₂ | 65 | 0.004 | 2270 | No |
| PEM12W12A- | (PEM- | 137 | 0.002 | 3160 | No |
| Ag | 2)₁₂ + Ag | | | | |

See FIG. 3: Potentiodynamic polarization curves from the PD-1 testing, bare SS316L wire (curve C), SS316L wire coated with 12 double layer PEM-2 polymers (curve B), and SS316L wire coated with 12 double layers of PEM-2 polymers and treated with silver solution (curve A)

### Example 3

### PEM2 Coatings with 2 Double Layers of Polymer A1 and Polymer B2

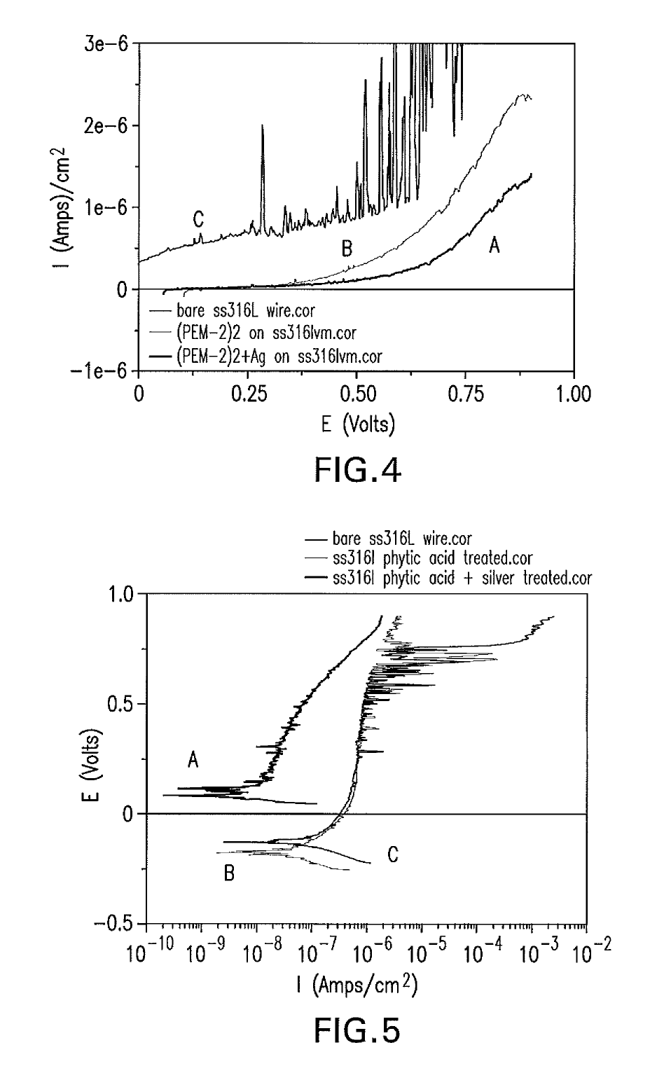

Polyelectrolyte multilayer coatings, with and without silver salts, comprising 2 instead of 20 double layers of polymer A1 and polymer B2 (PEM2)₁₂ were prepared on SS316LVM wires and tested as in Example 1. The PD-1 electrochemical corrosion testing results are shown in FIG. 4 and Table 4. The silver treated PEM2 coatings gave low corrosion current density (I_{corr}) and high corrosion potential (E_{corr}) and polarization resistance (Rₚ). The benefit of improved anticorrosion properties from incorporating silver ions in the PEM2 coatings is realized with PEM coatings of only 2 double layers.

TABLE 4
Data from PD-1 testing

| | | E_{corr} | I_{corr} | Rₚ | E_{b} |
|---|---|---|---|---|---|
| Wire ID | Coatings | mV | μA/cm² | kΩ * cm² | mV |
| Bare SS316L | No | −128 | 0.093 | 285 | 700 |
| PEM2W2 | (PEM-2)₂ | 127 | 0.002 | 1140 | No |
| PEM2W2-Ag | (PEM-2)₂ + Ag | 92 | 0.001 | 9280 | No |

See FIG. 4: Potentiodynamic polarization curves from the PD-1 testing, bare SS316L wire (curve C), SS316L wire coated with 2 double layer PEM-2 polymers (curve B), and SS316L wire coated with 2 double layers of PEM-2 polymers and treated with silver solution (curve A)

### Example 4

### Phytic Acid Monolayer with Silver Complex

Vacuum arc remelted stainless steel 316LVM (ASTM F138 chemistry) wires (1.25 mm in diameter) were abraded with SiC (1200 grit) sand paper degreased with isopropanol, and then washed with deionized water (DIW) in an ultrasonic bath for 10 minutes.

The freshly abraded and ultrasonically cleaned 316LVM stainless steel wires were immersed in a solution of 10 mM of phytic acid and 0.25 NaCl for 40 minutes, rinsed with deionized water for 1 minute and dried with nitrogen stream flow. Such phytic acid treated wires are identified by symbol Py for the phytic acid monolayer coating.

Phytic acid treated SS316LVM wires were immersed in a 0.25M silver nitrate aqueous solution overnight. The silver treated wires are rinsed with deionized water (DIW) and dried with a nitrogen stream and identified by symbol Py—Ag.

Electrochemical corrosion tests were carried out on coated and uncoated SS316LVM wires in 0.7M NaCl solution. The potentiodynamic polarization curves from the PD-1 testing are compared in FIG. 5 for bare SS316L wire (curve C), SS316L wire coated with monolayer of phytic acid (curve B), and SS316L wire coated with monolayer of phytic acid complexed with silver (curve A). Bare SS316L wires show significant pitting corrosion with a breakdown potential E_{b} of 700 mV, beyond which a sustained corrosion current occurs. The plot for bare wire also contains random current spikes indicating meta-stable pitting before pitting breakdown at 700 mV. The wires coated phytic acid monolayer (Py) exhibit improvement in corrosion resistance. No pitting breakdown up to the 900 mV potential is shown (E_{b}>900 mV) although the meta-stable pitting is still observed. Treatment of Py coated wires with AgNO₃ solution provides significantly further improvement in corrosion resistance. The anodic polarization current for Py+Ag coatings is significantly lower than that for Py coatings only and the meta-stable pitting is suppressed (FIG. 5). The free corrosion properties near OCP are improved significantly as shown by the data in Table 5. With silver solution treatment on the phytic acid coated SS316LVM wires, the corrosion potential, E_{corr}, increased from negative (<−128) to positive (>30 mV), corrosion current, I_{corr}, decreased about 5 times from about 25 to 5 nA/cm², and the polarization resistance, Rₚ, increased more than 2 times from 670 to 1520 kΩ*cm².

TABLE 5
Data from Zplot-1, PD-1 and PS-2 tests for SS316L wires
uncoated and coated with monolayer of phytic acid silver complex

| | | | | | | t_{b}(700 | | Z(0.05 |
|---|---|---|---|---|---|---|---|---|
| | | E_{corr} | I_{corr} | Rₚ | E_{b} | mV) | | Hz) |
| Wire ID | coatings | mV | μA/cm² | kΩ/cm² | mv | hr | | kΩ/cm² |
| Bare SS316L | no | −128 | 0.093 | 285 | 700 | 0 | | 30 |
| 16zs212PY | PY | −203 | 0.026 | 670 | No | 4 | h | 29 |
| 16zs212PY-Ag | (PY)Ag | 71 | 0.005 | 1520 | No | >14 | h | 92 |
| 16zs215Py-Ag | (Py)Ag | 30 | 0.004 | 1670 | No | >14 | h | 55 |

See FIG. 5: potentiodynamic polarization curves from the PD-1 testing for bare SS316L wire (curve C), SS316L wire coated with monolayer of phytic acid (curve B), and SS316L wire coated with monolayer of phytic acid complexed with silver (curve A)

### Example 5

### PEM3 Coatings with Polymers A13 (Dextran Sulfate) and B8 (Chitosan)

Freshly abraded and ultrasonically cleaned 316LVM stainless steel (SS316LVM) wires were immersed in a solution of 10 mM of phytic acid and 0.25 NaCl for 40 minutes, rinsed with deionized water for 1 minute and dried with nitrogen stream flow.

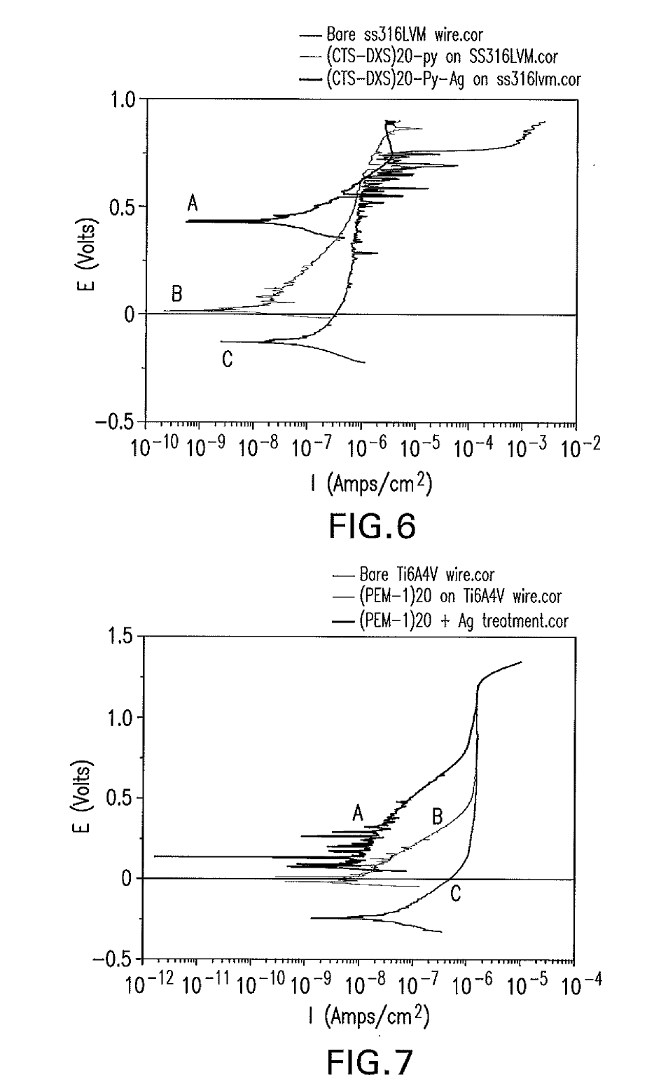

Polyelectrolyte multilayer coatings of 20 double layers were prepared on phytic acid treated SS316LVM wires ((CTS/DXS)₂₀-Py) in the same ways as described in Example 1 except that dextran sulfate (DXS) was used for polymer A and chitosan (CTS) for polymer B. Some of the ((CTS/DXS)₂₀-Py coated wires were treated with AgNO₃ solution the same way as described in Example 1 to obtain silver treated PEM3 coatings ((CTS/DXS)₂₀-Py—Ag). The PD-1 electrochemical corrosion testing results are shown in FIG. 6 and Table 6. Compared with SS316L wires coated only with monolayer of phytic acid (Py) and PEM3 on Py (CTS/DXS)₂₀—PY), the silver treated PEM3 coatings ((CTS/DXS)₂₀-Py—Ag) gave low corrosion current density (I_{corr}) and high corrosion potential (E_{corr}) and high polarization resistance (Rₚ).

TABLE 6
Data from Zplot-1, PD-1 and PS-2 tests for SS316L wires
uncoated and coated with PEM3.

| | | E_{corr} | I_{corr} | Rₚ | E_{b} |
|---|---|---|---|---|---|
| Wire ID | coatings | mV | μA/cm² | kΩ/cm² | Mv |
| Bare SS316L | no | −128 | 0.093 | 285 | 700 |
| 16zs212PY | PY | −203 | 0.026 | 670 | No |
| 16zs228PW | (CTS/DXS)₂₀-PY | 7 | 0.011 | 722 | No |
| 16zs228PW- | (CTS/DXS)₂₀-Py-Ag | 433 | 0.008 | 1380 | No |
| Ag2 | | | | | |

See FIG. 6. potentiodynamic polarization curves from the PD-1 testing for bare SS316L wire (curve C), SS316L wire coated with 20 double layers of PEM3 (curve B), and SS316L wire coated with 20 double layers of PEM3 and treated with silver (curve C)

### Example 6

### PEM1 Coatings of Polymers A2 and B7 on Titanium Alloy

Medical grade titanium 6AL 4V ELI (ASTM B348, B863, F136 Chemistry Only) alloy wires (1.25 mm in diameter were abraded with SiC (1200 grit) sand paper, degreased with isopropanol, and then washed with deionized water (DIW) in an ultrasonic bath for 10 minutes. Some of such cleaned wires were tested as is uncoated and served as a control for comparison.

Polyelectrolyte multilayer coatings of 20 double layers of polymer A2 and polymer B7 (PEM1)₂₀ are deposited on freshly abraded and ultrasonically cleaned titanium 6AI 4V (Ti6Al4V) wires using the above stated layer-by-layer deposition method. The PEM1 coatings are obtained from Polymer A solution made of 10 mM poly(styrenesulfonate) sodium salt (A2) in 0.25M NaCl aqueous solution and Polymer B solution made of 10 mM poly(diallyldimethylammonium chloride) (B7) in 0.25M aqueous solution.

PEM1+Ag coatings containing silver are obtained by treating PEM1 coated Ti6Al4V wires in 0.25M silver nitrate aqueous solution overnight. The treated wires are rinsed with deionized water (DIW) and dried with a nitrogen stream.

Electrochemical corrosion tests were carried out on coated and uncoated Ti6Al4V wires in 0.7M NaCl solution. The results are summarized in Table 7. The potentiodynamic polarization curves from the PD-1 testing are compared in FIG. 7 for bare Ti6Al4V wire (C curve), Ti6Al4V wire coated with 20 double layer PEM-1 polymers (B curve), and Ti6Al4V wire coated with 20 double layers of PEM-1 polymers and treated with silver solution (A curve).

Titanium alloys have the reputation of being high corrosion resistance. Indeed, the bare uncoated Ti6A4V wire did not show any pitting corrosion breakdown with applied anodic polarization up to 1100 mV in the PD-1 corrosion testing (FIG. 7). However, the Ti6A4V wire coated with PEM-1 coating (220TW) improved the corrosion resistance in the low potential region (<500 mV) by significantly increasing the corrosion potential value (E_{corr}) from −250 mV to −25 mV and reducing corrosion current density at the same applied potential.

Treatment of the PEM-1 coated wires with AgNO₃ solution provides significantly further improvement in corrosion resistance. The anodic polarization current for (PEM-1)₂₀+Ag coatings is significantly lower than that for (PEM-1)₂₀ coatings only (FIG. 7). The free corrosion properties near OCP are improved significantly as shown by the data in Table 7. With silver solution treatment on the PEM-1 coated Ti6AlV4 wires, the corrosion potential, E_{corr}, increased from −24 to 73 mV, corrosion current, I_{corr}, decreased significantly, and the polarization resistance, Rₚ, increased.

This example demonstrated that incorporating silver in PEM coatings can also significantly improve anticorrosion properties of titanium alloys.

TABLE 7
Data from Zplot-1, PD-1 and PS-2 tests for Ti6Al4V wires
uncoated and coated with 20 double layers of PEM1 coatings

| | | E_{corr} | I_{corr} | Rₚ | E_{b} | t_{b}(700 mV) | Z(0.05 Hz) |
|---|---|---|---|---|---|---|---|
| Wire ID | coatings | mV | μA/cm² | kΩ/cm² | mv | hr | kΩ/cm² |
| Bare Ti6Al4V | No | −248 | 0.068 | 704 | >1100 | >14 | 51 |
| 220TW | (PEM1)₂₀ | −24 | 0.044 | 2650 | >1100 | >14 | 49 |
| 220TW-Ag | (PEM1)₂₀ + Ag | 73 | 0.002 | 3720 | >1100 | >14 | 89 |

See FIG. 7. Potentiodynamic polarization curves from the PD-1 testing for bare Ti6Al4V wire (curve C), Ti6Al4V wire coated with 20 double layer PEM-1 polymers (curve B), and Ti6Al4V wire coated with 20 double layers of PEM-1 polymers and treated with silver solution (curve A).

### Example 7

### Single Polymer (PSt-b-P2VP) Coatings on SS316LVM

Vacuum arc remelted stainless steel 316LVM (ASTM F138 chemistry) wires (1.25 mm in diameter were abraded with SiC (1200 grit) sand paper, degreased with isopropanol, and then washed with deionized water (DIW) in an ultrasonic bath for 10 minutes. Some of such cleaned wires were tested as is uncoated and served as a control for comparison.

Block copolymer of polystyrene and polyvinylpyridine (PSt-b-P2VP) was prepared by anionic polymerization. The PSt-b-P2VP block copolymer used in this example has a PS/P2VP composition ratio of 1.0 and a weight average molecular weight (Mw) of about 65,000 with a polydispersity of 1.31 as determined by GPC using narrow molecular weight polystyrene standards.

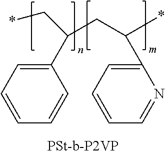

PSt-b-P2VP polymer coatings were prepared on freshly cleaned SS316L wires by dipping two times in a 2.5% by weight of the PSt-b-P2VP polymer solution in PGMEA (propylene glycol monomethyl ether acetate) and air dried.

PSt-b-P2VP+Ag coatings containing silver are obtained by treating PSt-b-P2VP coated SS316LVM wires in 0.25M silver nitrate aqueous solution for four hours. The treated wires are rinsed with deionized water (DIW) and dried with a nitrogen stream.

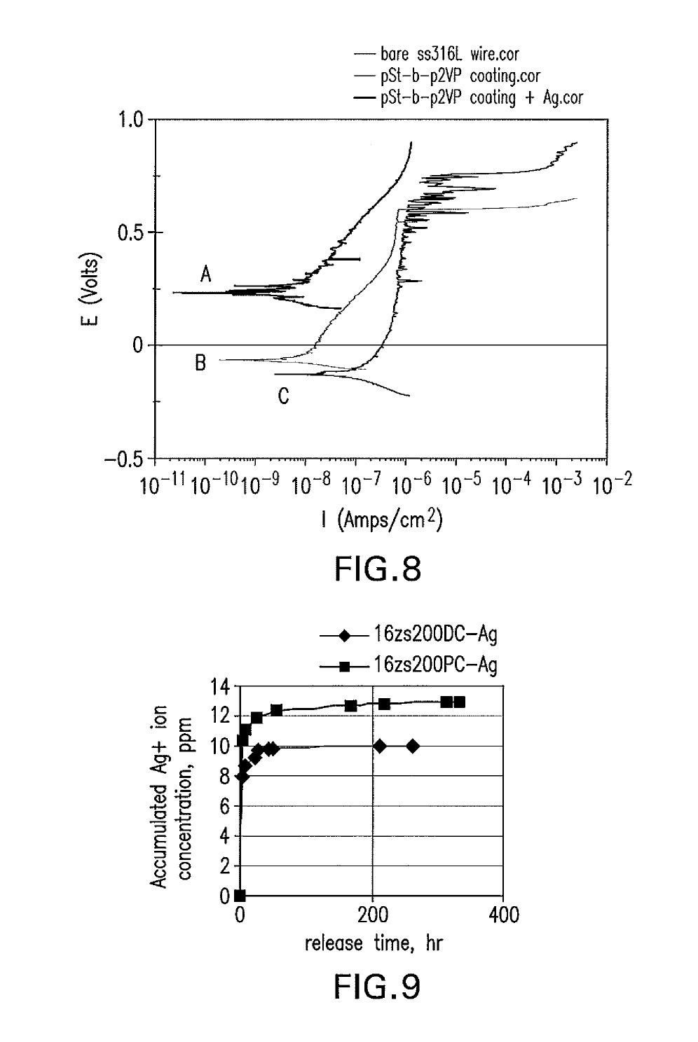

Electrochemical corrosion tests were carried out on coated and uncoated SS316LVM wires in 0.7M NaCl solution. Results are summarized and in Table 8. The potentiodynamic polarization curves from the PD-1 testing are compared in FIG. 8 for bare SS316L wire (black curve), SS316L wire coated with PSt-b-P2VP only (red curve), and SS316L wire coated with PSt-b-P2VP and treated with silver solution (blue curve). Bare SS316L wires show significant pitting corrosion with a breakdown potential E_{b} of 700 mV, beyond which a sustained corrosion current occurs. The plot for bare wire also contains random current spikes indicating meta-stable pitting before pitting breakdown at 700 mV. The wires coated with only PSt-b-P2VP improved free corrosion resistance at low anodic potential but deteriorated pitting corrosion breakdown resistance. The free corrosion potential E_{corr} is increased, corrosion current I_{corr} reduced, and the meta-stable pitting suppressed with PSt-b-P2VP coating. However, the pitting breakdown still occurs and is reduced to 600 mV potential.

Treatment of the PSt-b-P2VP coated wires with AgNO₃ solution provides significantly improvement in corrosion resistance. The anodic polarization current for PSt-b-P2VP+Ag coatings is significantly lower than that for PSt-b-P2VP coating only (FIG. 8). The free corrosion properties near OCP are improved significantly as shown by the data in Table 8. With silver solution treatment on the PSt-b-P2VP coated SS316LVM wires, the corrosion potential, E_{corr}, increased from −66 to 228 mV, corrosion current, I_{corr} decreased about 4 times from about 4 to 1 nA/cm², and the polarization resistance, Rₚ, increased more than 3 times from 2530 to 9860 kΩ*cm². Most valuable, the incorporation of silver in PSt-b-P2VP polymer coatings suppressed pitting breakdown and could withstand long term corrosion test of PS-2 at 700 mV anodic polarization for more than 14 hours.

TABLE 8
Data from Zplot-1, PD-1 and PS-2 tests for SS316LVM
wires uncoated and coated with PSt-b-P2VP

| | | Z(0.05 Hz) | E_{corr} | I_{corr} | Rₚ | E_{b} | t_{b}(700 mV) | |
|---|---|---|---|---|---|---|---|---|
| Wire ID | coatings | kΩ/cm² | mV | μA/cm² | kΩ*cm² | mV | hr | |
| Bare SS316L | No | 30 | −128 | 0.093 | 285 | 700 | 0 | |
| 16zs243A | pSt-b-P2VP | 128 | −66 | 0.004 | 2530 | 600 | 0 | |
| 16zs243A + Ag | pSt-b-P2VP + Ag | 109 | 228 | 0.001 | 9860 | No | >14 | h |

See FIG. 8: potentiodynamic polarization curves from the PD-1 testing for bare SS316L wire (curve C), SS316L wire coated with PSt-b-P2VP only (curve B), and SS316L wire coated with PSt-b-P2VP and treated with silver solution (curve A).

### Example 8

### Silver Ion Incorporation and Release for Antimicrobial Applications

This example demonstrates that silver incorporated in the polymer coatings for anticorrosion improvement according to present invention can also be available for releasing silver ions to give antimicrobial effect.

Twenty double layers of pDADDAA/PSSMA (PEM-2) were coated on 5×5 cm square type 316 stainless steel coupons with (16zs200PC) and without (16zs200DC) phytic acid pre-treatment. The PEM-2 coated coupons were immersed in 0.25M AgNO₃ solution overnight to load silver ions and rinsed with deionized water and dried by nitrogen blow at room temperature. The thus silver loaded coupons were immersed in 30 g of deionized water for releasing silver ions. At time intervals, the coupons were removed from the Ag+ released water and placed into 30 g of fresh water for another cycle of Ag+ releasing. The concentration of silver ions in the Ag+ released water was determined using a Ag/AgS silver ion selective electrode (Ag ISE). The results are shown in FIG. 9. The total amount of silver ions loaded to the PEM coatings can be estimated from the releasing experiments to be about 6.0 and 7.8 μg/cm² for 16zs200DC and 16zs200PC, respectively. It appeared that phytic acid (16zs200PC) can improve the Ag+ ion loading capacity. The silver loaded PEM-2 coatings on the SS316 coupons with 50 cm² surface area can maintain about 0.7 ppm of silver ion in 30 g of water after the second water change. The Ag+ concentration decreased with each fresh water change but still above 0.1 ppm after the 5th water change. These levels of Ag+ ion concentration in water is likely to give desirable antimicrobial effect. It has been reported that silver ion levels of 0.1 to 1 ppm was enough to inhibit (MIC) a variety of bacterial growth including E. coli and S. aureus (T. J. Berger et. Al, Antimicrobial Agents and Chemotherapy, 9 (2), February 1976, p 357-358).

See FIG. 9. Silver ion release in water from the silver loaded PEM-2 coatings

1. A coated metal substrate, wherein the metal substrate is coated with a film comprising
i.) a polymer binder,
ii.) an antimicrobial metal,
wherein the polymer binder comprises polymers selected from the group consisting of polyelectrolytes containing charged and/or potentially chargeable groups
and
polymers containing hydrophilic entities,
wherein the antimicrobial metal is selected from the group of metals consisting of silver, copper, gold, iridium, palladium and platinum,
and
iii.) optionally, phytic acid or salts thereof.

2. A coated metal substrate according to claim 1, wherein the antimicrobial metal is an antimicrobial metal salt or ion.

3. The coated metal substrate of claim 1 wherein the polymer binder comprises a polyelectrolyte complex derived from a positively-charged (cationic) polyelectrolyte and a negatively charge (anionic) polyelectrolyte.

4. The coated metal substrate of claim 3 wherein the cationic polyelectrolyte (B) are homopolymers or copolymers of diallyldimethyl ammonium chloride (DADMAC), diallyldimethyl ammonium bromide, diallyldimethyl ammonium sulfate, diallyldimethyl ammonium phosphates, dimethallyldimethyl ammonium chloride, diethylallyl dimethyl ammonium chloride, diallyl di(beta-hydroxyethyl)ammonium chloride, diallyl di(beta-ethoxyethyl)ammonium chloride, dimethylaminoethyl(meth)acrylate acid addition salts and quaternary salts, diethylaminoethyl(meth)acrylate acid addition salts and quaternary salts, 7-amino-3,7-dimethyloctyl(meth)acrylate acid addition salts and quaternary salts, N,N′-dimethylaminopropyl acrylamide acid addition salts and quaternized salts, wherein the quaternary salts include alkyl and benzyl quaternized salts; allylamine, diallylamine, vinylamine (obtained by hydrolysis of vinyl alkylamide polymers), vinyl pyridine, chitosan, cationic starch, polylysine and salts thereof.

5. The coated metal substrate of claim 3 wherein the polyelectrolyte anionic polymers (A) are homopolymers or copolymers of (meth)acrylic acid, maleic acid (or anhydride), styrene sulfonic acid, vinyl sulfonic acid, allyl sulfonic acid, acrylamidopropyl sulfonic acid, alginic acid, carboxymethylcellulose, dextran sulfate or poly(galacturonic acid) or salts thereof.

6. The coated metal substrate of claim 1 wherein the polymer binder is a polymer containing hydrophilic entities and forms a water-insoluble film and the hydrophilic entities include copolymers of styrene and vinylpyridine, homopolymers and copolymers of vinylpyridine, homopolymers and copolymers of terbutylaminoethyl methacrylate.

7. The coated metal substrate of claim 1 wherein the substrate is steel, aluminum, titanium, chromium, cobalt mixtures or alloys thereof.

8. The coated metal substrate of claim 1 wherein the substrate is at least part of a medical device or implant.

9. A method of protecting a metal substrate from corrosion, substrate metal ion release and microbial activity by
coating the substrate with a film comprising a polymer binder, an antimicrobial metal and optionally phytic acid or salts thereof,
wherein the polymer binder comprises polymers selected from polyelectrolytes containing charged and/or potentially chargeable groups and
polymers containing hydrophilic entities
and the antimicrobial metal is selected from silver, copper, gold, iridium, palladium or platinum.

10. The method according to claim 9, wherein the antimicrobial metal is a salt or ion.

11. The method according to claim 9, wherein the polymer binder is applied to the substrate in a first step to produce a coated substrate and the antimicrobial metal is incorporated into the binder in a second step by contacting the coated substrate with a solution of the antimicrobial metal.

12. The method according to claim 10 wherein the antimicrobial metal is a silver salt selected from silver nitrate, silver citrate, silver acetate, silver fluoride, silver permanganate and silver sulfate.

13. The method according to claim 9 wherein the antimicrobial metal is incorporated into the polymer binder in a first step and then applying the antimicrobial metal containing polymer binder to the substrate.

14. The method according to claim 9 wherein the polymer binder comprises a polyelectrolyte complex derived from a positively-charged (cationic) polyelectrolyte and a negatively charge (anionic) polyelectrolyte.

15. The method according to claim 14 wherein the polyelectrolyte complex is formed by layer by layer deposition.

16. The method according to claim 15 wherein the polyelectrolyte complex is formed by a sequence wherein the substrate is immersed or dipped into a solution of a cationic polymer and in a subsequent step is immersed or dipped into a solution of an anionic polymer wherein the sequence is optionally repeated.

17. The method according to claim 9 wherein the polymer binder containing hydrophilic entities and forms a water-insoluble film and comprises hydrophilic entities include copolymers of styrene and vinylpyridine, homopolymers and copolymers of vinylpyridine, homopolymers and copolymers of terbutylaminoethyl methacrylate.

18. The method according to claim 14 wherein the cationic polyelectrolyte (B) is a homopolymer or copolymer of diallyldimethyl ammonium chloride (DADMAC), diallyldimethyl ammonium bromide, diallyldimethyl ammonium sulfate, diallyldimethyl ammonium phosphates, dimethallyldimethyl ammonium chloride, diethylallyl dimethyl ammonium chloride, diallyl di(beta-hydroxyethyl)ammonium chloride, diallyl di(beta-ethoxyethyl)ammonium chloride, dimethylaminoethyl(meth)acrylate acid addition salts and quaternary salts, diethylaminoethyl(meth)acrylate acid addition salts and quaternary salts, 7-amino-3,7-dimethyloctyl(meth)acrylate acid addition salts and quaternary salts, N,N′-dimethylaminopropyl acrylamide acid addition salts and quaternized salts, wherein the quaternary salts include alkyl and benzyl quaternized salts; allylamine, diallylamine, vinylamine (obtained by hydrolysis of vinyl alkylamide polymers), vinyl pyridine, chitosan, cationic starch, polylysine and salts thereof.

19. A method according to claim 14, wherein the polyelectrolyte anionic polymers (A) are homopolymers or copolymers of (meth)acrylic acid, maleic acid (or anhydride), styrene sulfonic acid, vinyl sulfonic acid, allyl sulfonic acid, acrylamidopropyl sulfonic acid, alginic acid, carboxymethylcellulose, dextran sulfate or poly(galacturonic acid) or salts thereof.

20. The method according to claim 9 wherein the substrate is at least a part of a medical device or implant.

21. A kit of parts for the manufacture of a corrosion resistant metal substrate, comprising a first part (A) comprising an anionic polyelectrolyte containing strongly and negatively charged groups and a second part (B) comprising a cationic polyelectrolyte containing strongly and positively charged groups
or
a third part (C) comprising a polymer containing hydrophilic entities
and
a forth part (D) comprising an antimicrobial metal,
and optionally, a fifth part (D) comprising phytic acid or salts thereof,
which parts when applied to the metal substrate form a coated metal substrate according to claim 1.
